(19) United States
(12) Patent Application Publication
(10) Pub. No.: US 2003/0016661 A1
(43) Pub. Date: Jan. 23, 2003

(54) Telephone switching system for integrating the internet with the public switched telephone network

(76) Inventor: Harry E. Emerson III, Succasunna, NJ (US)

Correspondence Address: Ernest D. Buff, Ernest D. Buff & Associates, LLC, 245 South Street, Morristown, NJ, 07960, US

(21) Appl. No.: 10/195,227

(22) Filed: Jul. 15, 2002

Related U.S. Application Data
(60) Provisional application No. 60/306,294, filed on Jul. 18, 2001.

(51) Int. Cl. H04L 12/66

(52) U.S. Cl. 370/352; 379/88.17

(57) ABSTRACT

A method and means for a telephone central office switching system facilitate integration of the Internet and the Public Switched Telephone Network. The method and means enable specific messaging communications from the telephone central office switching system to (i) individual terminal devices, (ii) interface devices that provide Internet and telephony services for their client devices, and (iii) other telephone central office switching systems. Such integration enables a calling device to achieve an Internet communication with a called device by dialing the telephone number of the called device.

### BACKGROUND OF THE INVENTION

This application claims the benefit of U.S. Provisional Application No. 60/306,294, filed Jul. 18, 2001, entitled “Telephone Switching System For Integrating The Internet With The Public Switched Telephone Network”.

1. Field of the Invention

The present invention relates to the Internet and the Public Switched Telephone Network (PSTN); and more particularly to the integration of the Internet with the PSTN in a manner that enables systems, services, and devices on either to communicate with systems, services, and devices on the other, so that the full benefit and unique characteristics of either network are available to these communications.

2. Description of the Prior Art

At the present time, the Internet and the PSTN are discrete, independent networks from an architectural and operational perspective. Much is written about both networks, especially in terms of their architecture and operation. Consequently, the specification provided herewith does not reconstruct that information other than providing general background information. The term “Internet” is commonly understood and used throughout the specification and claims in a conventional way. The Internet, in general, is an assemblage of interconnected routers that provide data transport services for server computers and user devices—typically PCs. The interconnection between routers is provided by private line data circuits, the main lines of which constitutes the Internet “backbone”. Internet Service Providers (ISPs) provide access to the Internet via dial up telephone lines with modems, and via dedicated arrangements such as T-1 circuits, cable modems on cable-TV systems, and DSL (Digital Subscriber Line) service.

The Internet is designed according to the Internet Protocol (IP), which provides detailed specifications for the construction, addressing, and routing of data packets (occasionally referred to as “messages” in this document). (The term “Internet Protocol” also is used loosely to refer to dozens of related protocols that are used in the Internet.) IP addresses are expressed as a series of digits separated by “dots” (periods), in the form XXX.XXX.XXX.XXX where XXX can be a number from 0 to 255. IP addresses provide a similar function on the Internet as telephone numbers provide on the PSTN. A communication with an Internet device can be established by sending a message addressed to the IP address of that device. Every device capable of communicating on the Internet has an IP address assigned to it, either permanently, or dynamically as needed. IP addresses in some environments are replaced with a proxy address; for purposes of this document, the term “IP address” shall refer to an actual IP address, or a proxy or other identifier translatable into an actual IP address. In some of these arrangements, the IP address may be indirectly associated with the device. For example, in a wireless handset arrangement, the provider's complex might provide Internet connections for wireless handsets on a proxy basis wherein the complex keeps track of IP number assignments used for each handset, but communicates with each handset based on a serial number or other unique identifying scheme. The same goal is accomplished, i.e. an Internet capable handset gets its own IP address, but with one level of indirection. In other arrangements proxies or agents act on behalf of a client system and substitute the proxy's IP addresses for the addresses of the client devices—in these arrangements the combination of the proxy address and the original client system address resolve to provide a unique IP address for each client system. Internet data packets contain the IP address of both the sending system and receiving system (the source and destination, respectively). Since IP messages always contain the IP addresses of both the sending and destination device, when a device receives an Internet message from a sending device, it will then possess the IP address of the sender and can send messages in reply. The two devices can then engage in a communication across the Internet since each has the IP address of the other.

Routers have internal tables that provide routing instructions that relate IP addresses to the available data circuits and access lines. A router functions by reading the destination address in a data packet, and then forwarding the data packet on one of its data circuits or access lines according to the rules of the routing tables. A data packet gets forwarded from one router to another, pinballing its way across the Internet until it reaches a router that is connected to the destination system.

The term “Public Switched Telephone Network”, or “PSTN”, as used herein, means the national and international telephone network, actuated when a user dials a telephone number associated with any other phone, causes it to ring, and if answered, is enabled to carry on a voice communication (or, more properly, a “voice grade” communication) with the person (or system) at the remote location. Just as the Internet is comprised of an aggregation of interconnected routers, the PSTN is comprised of an aggregation of interconnected local and long distance telephone switching systems. The local switching systems, referred to as telephone company (telco) central offices (CO), provide telephone subscriber services in a geographic area

As used herein, the term “telephone central office switching system” refers generically to a class of systems, typically owned by the operating telephone company in any given area, which provide “local” telephony services to telephone subscribers in that area. Characteristically, the operating telephone company provides the “local loop” cabling and wiring from its central office to the physical location of each of their subscribers (a “telephone circuit”, or a “line”). A telephone central office might house several switching systems of this class, each serving up to 100,000 subscribers or more. The central office represents the hub of a wheel having thousands of spokes, each spoke being a physical pair of wires providing telephone service to a subscriber in that area. Subscribers in any given area are provided service by the central office situated in the center of the area. Outside that area the wires home to other similarly situated central offices. The telephone company connects the telephone circuit of a subscriber to an access connection on the switching system, and assigns a telephone number to that circuit. In operation, the switching system (or just “switch”) provides battery voltage on the phone line, sends dial tone to the subscriber line when the subscriber's phone goes off hook, receives the dialed digits, and then routes the call according to its internal instructions based on the called number.

Common manufactured switching systems of this class include the Lucent Technologies 5ESS, and the Nortel DMS100. All telephone central office-switching systems around the world are interconnected by “trunk” circuits that carry voice or voice grade telephone calls between systems; and most (if not all) such systems are also interconnected by a messaging network referred to as CCS/SS7 (Common Channel Signaling/Signaling System 7), or just SS7. Long distance calls to telephones outside of the area served by the local telephone company are typically routed to a long distance carrier, such as AT&T, MCI, or Sprint in the U.S.A. The telephone central office switches connect via trunking and messaging circuits to a class of switching system referred to as a “toll switch”, such as the Lucent Technologies 4ESS, operated by a long distance carrier. Toll switches normally do not provide local telephone services.

In the current state of the art there are two inter-related messaging systems utilized within the PSTN. These are: (i) SS7; and (ii) ISDN (Integrated Services Digital Network), which incorporates a messaging system as an element of a broader product and service architecture. The SS7 messaging system extends through the major elements and systems of the PSTN, connecting virtually all of the local and long distance central offices, and carries call management (or call control) messages relating to call setup and disconnection and similar call management functions. Whereas the SS7 messaging system is oriented toward providing messaging communications among and between the PSTN switching systems, the ISDN messaging system is oriented toward extending the PSTN messaging system to the end devices such as telephones and office telephone systems. Rather than going off hook and drawing dial tone from the local central office switching system to initiate a call, as analog phones do, an ISDN phone sends a packetized digital call setup message to the switching system to initiate a call. Both the ISDN messaging system and the SS7 messaging system are based on the X.25/X.75 communications protocols. ISDN messages are carried on the SS7 messaging network. Disadvantageously, neither the SS7 nor the ISDN messaging systems carry any messages related to creating an Internet communication by one device dialing the telephone number of another.

The ISDN and SS7 messaging systems are call setup and call management (or call control) systems which carry a spectrum of messages, message responses, message acknowledgements, and the like, such as are necessary to conduct telecommunications. A full listing of all the message types that might be employed in a robust telecommunications environment has not been attempted herein, since that depth of information is not necessary to convey the essential elements of this invention. A brief listing of those message types include: (i) call setup request messages which convey dialing and associated information; (ii) busy signal messages telling the calling device to deliver a busy signal to the user; (iii) audible ring back messages telling the calling device to deliver “pacifier” ringing to the user; (iv) call request acceptance or rejection messages (v) call connect messages; (vi) call disconnect messages; (vii) switchhook flash messages; (viii) call transfer request messages; (ix) call conference messages; (x) call waiting messages; (xi) Caller-ID and Call Waiting-ID messages; and (xii) call forwarding messages to redirect a call to another device. In addition to these messages, a variety of other messages would be employed to indicate information like “network busy”, “invalid telephone number dialed”, and the like.

Conventional communication vehicles comprise computers and telephones. Computers typically have telephone lines attached to them, and telephones oftentimes have computers attached to them; but there is no true integration that enables the blending of the Internet and the PSTN. The level of integration that is presently attained permits a computer to use a phone line to dial into the Internet. Once on the Internet, the computer can access another computer by entering its Internet Protocol (IP) address into application software such as a browser.

In an associated matter, there are now a variety of technologies that provide both Internet and PSTN connectivity. These technologies include: (i) Voice over IP (ii) DSL service; (iii) cable modem service delivered by cable-TV systems; (iv) fixed wireless systems; and (v) Internet capable cellular wireless systems. The following provides a brief review of these technologies.

One of the technologies mentioned above is Voice over IP service. The term IP refers to the “Internet Protocol”, the basic protocol of the Internet, while the term Voice over IP refers to sending digitized voice across the Internet using the IP protocol. Several companies provide discount rate phone calls using “Voice over IP” (VoIP) technology, wherein a long distance call of a client, typically a Personal Computer (PC) user, is carried over the Internet to a VoIP interface device in the vicinity of the called party. Such VoIP technology avoids the charges associated with placing a long distance call with a traditional long distance carrier. The VoIP interface device dials a local call on the PSTN to complete the connection for the VoIP client. Hence, the call travels partially over the Internet and partially over the PSTN as an analog call. A VoIP software application at the client device digitizes the user's voice and sends that as data messages across the Internet to the VoIP interface device. The VoIP interface device in turn converts the data messages to analog signals that are output onto the analog phone line. In the reverse direction, the VoIP interface device receives analog signals from the dialed phone and converts those analog signals to digital messages, which it sends across the Internet to the VoIP client. The VoIP software at the client converts those digital messages to analog signals, which are output to the user via speakers.

A second technology is an Internet access technology currently being deployed that is referred to as DSL (Digital Subscriber Line) service. (The original acronym was ADSL, for Asynchronous Digital Subscriber Line.) Although there are some variations on the technology (now generically referred to as “xDSL”), it essentially involves an analog telephone line supplemented by a high frequency carrier signal superimposed on the telephone line by a pair of modems—one at the subscriber location, and one at the telephone company central office. The DSL carrier signal can carry high-speed data concurrently over the same phone line without interfering with the analog phone service. Other than being carried by the same physical wires, the phone line has no relationship to the DSL Internet service.

Another technology relates to virtual phone service provided via cable-TV. Cable-TV service has been used to provide high-speed Internet access - the popular “cable modem” service. In addition, there are a number of current activities related to delivering alternative provider telephone service via the cable-TV distribution system. Similar to the Internet access service arrangement, the telephony service arrangement utilizes a “cable modem” to transmit and receive voice grade telephone calls. Other than being carried by the same physical cable, telephone service provided by cable-TV has no relationship to the cable modem Internet service.

A related matter is that of virtual phone service provided by the so-called fixed wireless arrangement, currently undergoing field trials in some areas, and by the newly introduced cellular telephone service with Internet access. Although these are substantially different services from a user perspective, the wireless infrastructure is much the same.

In each of these technologies, even though they provide both Internet and PSTN connectivity, the Internet aspect is separated from the telephony aspect. Furthermore, none of these technologies enables one device to create an Internet communication with another device simply by dialing its telephone number.

Full benefits of integrated communications are not attained in current Internet and telecommunications environments. ISDN service and DSL service are representative of current telephony environments. These environments are accordingly addressed hereinafter as operation of the telephone central office switching system is described in relation thereto. In that ISDN service and DSL service are representative of current telephony environments, the operation of the telephone central office switching system will be addressed in relation to these services.

In FIG. 1 there is shown a conventional arrangement in which two telephone central offices provide telephone services to four devices, two of which are connected to the Internet via a LAN connection, and two of which are connected to the Internet via DSL connections. FIG. 1 depicts the Internet 10, and telephone central offices 12 housing switching systems 14, which are interconnected by trunks and SS7 messaging circuits 16. The central office on the left provides telephone service to Personal Computers (PCs) or similar terminals 22 via ISDN lines 18. ISDN is a telephony technology, which incorporates a digital messaging capability in conjunction with digital voice transmissions. Terminals 22, one labeled “A”, the other “B”, reside on a LAN (Local Area Network) 24, which provides connectivity to the Internet 10 via high speed access line 26, typically a T-1 line. The central office 12 on the right provides DSL telephone service to PCs or similar terminals 28 (“C”) and 30 (“D”) via a DSL interface device 32, which incorporates DSL modem circuit cards 34. DSL is a service that uses a carrier wave technology to transmit high-speed data over an analog telephone line without interfering with the analog telephone operation. Carrier wave modems are used at each end of the circuit to originate and terminate the carrier wave signal, and to encode and decode data transmitted by the carrier wave signal. Switching system 14 has analog telephone lines 36 connecting to DSL interface device 32. Composite analog/carrier wave circuit lines 40 emanate from the DSL interface device 32 connecting to terminal C (28), and to DSL modem 38 for terminal D (30). Terminal C (28) incorporates DSL modem capability (not shown). DSL modem 38 terminates the carrier wave for terminal D (30) and splits out an analog circuit for telephone 44 and an Ethernet circuit 42 to the Integrated Device terminal 30. High-speed data traverses the Ethernet 42 and carrier wave 40 circuits to the DSL interface device 32, and then traverses access line 26 to and from the Internet.

In an optimal configuration, since all of terminals A, B, C or D have a telephone line and number, and have an Internet connection with an associated IP address, any of these terminals should be able to call any other of these terminals by dialing the associated phone number, and thereby be able to create a high-speed Internet communication. However, there exists no logical association between the Internet connectivity and the PSTN telephone connectivity, as previously described. As a result, such communications are not possible with systems presently designed.

In view of the foregoing, it is apparent that current technology does not enable a telephone central office switching system in one of these current environments to create an Internet connection when a calling device dials the telephone number of a called device. Accordingly, there remains a need in the art for a method and means enabling telephone central office switching systems to integrate the Internet with the PSTN.

### SUMMARY OF THE INVENTION

The present invention provides a method and means for a telephone central office switching system to engage in specific messaging communications to individual telephony and Internet devices. Such messaging facilitates end-to-end Internet communications by enabling a calling device to create an Internet communication with another device simply by dialing its telephone number, thus integrating the Internet with the PSTN. Co-pending patent applications, discussed in later passages, describe various aspects of this integration. One benefit of such integration is that traditional voice-only telephone calls can be augmented or replaced with multimedia communications using Internet protocols and capabilities. Such multimedia communications may include: voice and other audio; graphics, images and other visual material; motion video; and synchronized audio and video transmitted together including TV video and videophone service. The data for these multimedia communications may be transmitted on the Internet as a result of the integration described herein. Significantly enhanced capabilities provided by the present invention facilitate that integration.

In the present application, there is described the nature and operation of unique features of a telecommunications central office switching system which provides the necessary messaging capabilities and performs associated functions. Specifically, the central office switching system obtains the IP address of either the calling or called device, and provides that IP address to the other device via the messaging capability. If either of the calling or called devices is provided with the IP address of the other, it may initiate an Internet communication with the other device by sending an appropriate message addressed to the other device's IP address. The Internet Protocol incorporates the IP address of the sender and the receiver in every message. When one device initiates an Internet communication to the other, the receiver automatically learns the IP address of the sender and a two-way communication can commence.

There are a variety of ways to obtain the IP address of a calling or called device. In each such arrangement, there are provided telephone number cross-references that contain the IP address associated with the telephone number of an Integrated Device. In simple terms, Internet devices or telephone devices wishing to communicate with an Integrated Device known by a telephone number can determine if that telephone number has an IP address associated with it by looking it up in a cross-reference, or by having an agent such as a telephone central office perform that lookup. Cross-references of IP addresses to telephone numbers are maintained in the Internet, in the PSTN, in the device, or in any combination of the three.

Once an IP address has been obtained for a calling or called device it must be delivered to the other device. This invention also provides a means for delivering the IP address of one device to the other. In general terms, this comprises an addressable digital messaging arrangement such that digital messages can be sent to one or the other of the two devices. The Internet, of course, satisfies this requirement and is suitable in some scenarios. However, there also are other available technologies suitable for sending addressable digital messages in a telecommunications environment, such as the SS7 network and the messaging component of ISDN service (Integrated Services Digital Network). This aspect of the invention inherently requires that the sender know the digital address of the device to which the message will be sent. In some scenarios, that address will be an IP address, perhaps discovered from a cross-reference. In other scenarios, such as an ISDN environment, that address is automatically tied to the telephone number, so one device only needs to know the telephone number of the other to send it an ISDN message. In yet other scenarios, the telco switching system will know that address from subscriber records.

The messaging communications facility carries call management (e.g., call setup, call control), telephone number, and IP address messages to and from the switching system, switching system interface devices, and to and from the terminal (user) communications devices. A purpose of the messaging is to provide the calling or called device, or both, with information adequate to conduct a communication between themselves over the Internet when that communication was started by one device calling the telephone number of the other device on the PSTN.

There are several possible messaging systems that the PSTN might use to obtain an IP address and to notify the calling or called device of the remote device's IP address. The messaging communications as specified in this patent application utilizes one or more of these existing technologies. The messaging communications extends directly or indirectly to one or the other or both of the calling and called devices. Worldwide PSTN has the SS7 messaging system interconnecting all the major switching centers. Telephone companies could use SS7 for this purpose, for example, by forwarding an IP/phone number query to the serving agency of the called device via SS7, and receiving the query response and IP address by SS7. Alternatively, the PSTN could use an existing messaging technology such as the digital messaging capability incorporated into the Integrated Services Digital Network (ISDN), or Analog Display Screen Interface (ADSI). As still another alternative, the PSTN might have Internet access in order to communicate with the calling device via an Internet message. Since multiple workable arrangements are possible, it is merely necessary that the PSTN have a method of sending appropriate messages to one or the other or both of the calling and called devices.

The ADSI messaging capability mentioned above is a simplistic messaging technology of modest success, which is an outgrowth of Caller-ID. ADSI is a superset of the Automatic Number Identification (ANI) protocol used by Caller-ID and Call Waiting-ID. The terminology ADSI is used generally herein to encompass ADSI, ANI, Caller-ID, and Call Waiting-ID. ADSI provides 1200 bit per second modem communications messaging between a telephone central office and an analog ADSI phone, or between two ADSI phones, one acting as a server. The messaging is interruptive, in that modem connections use the voice frequency band. At any moment, an analog telephone line can carry either a voice conversation or an ADSI modem connection, but not both. For example, Call Waiting ID interrupts the called party's audio for a second or so while ADSI Call Waiting data (the calling phone number) is being received. The data rate is also very slow, and so has limited applications. Nevertheless, since Caller-ID, Call Waiting ID, and some other services have been implemented using ADSI, it would be advantageous for the PSTN messaging system to optionally have available a messaging system mode that is compatible with ADSI. The utility might be limited, but might be suitable for some purposes, products, price ranges, and the like.

Devices for integrating the Internet with the PSTN (“Integrated Devices”), as specified in the co-pending patent applications, have both an Internet connection with an associated IP address, and have a telephone connection with an associated telephone number. The telephone connection to the PSTN could be a virtual telephone line, such as that being provided over cable-TV systems. Additionally, Integrated Devices provide a cooperative messaging communications capability for communicating call setup and call control messages with the PSTN wherein the messages convey telephone number and IP address information.

As mentioned above, cross-references of IP addresses to telephone numbers could be maintained in the Internet, in the PSTN, in the terminal (user) device, or in any combination of the three. The Internet already maintains a cross-reference system, referred to as the Domain Name Service (DNS), which allows an Internet “site” or “location” to be publicly known by an alphanumeric name, such as Sears.com or Toyota.com, rather than by the strictly numerical IP address. (A master registry is maintained by the InterNIC organization, and is copied daily to thousands of DNS servers around the world.) This DNS service could be expanded to also maintain telephone numbers for these Internet locations. In addition, the cross-reference of IP addresses to telephone numbers could be indirect via the use of names by looking up a telephone number (TN) to find a name, then looking up the name to find the IP address. In the more straightforward version of this arrangement, if an Internet device wished to communicate via the Internet to a device known by a telephone number, it could query an appropriate DNS server for the telephone number. If the called device is listed in the DNS server as having an IP address, the calling device will receive that information back from the query. The calling device may then communicate with the called device via the Internet.

In another cross-reference arrangement, each of the Integrated Devices knows its own TN and IP numbers; the Integrated Devices themselves provide the cross-reference of telephone number to IP address. Calling and called devices exchange this information using available techniques such as the messaging system incorporated into ISDN.

In a third cross-reference arrangement, the PSTN maintains a cross-reference of telephone numbers having associated IP addresses. In this arrangement, when a device, having an IP address, calls a second device, also having an IP address, the PSTN notifies the caller of the called device's IP address via a digital messaging arrangement (or optionally, notifies the called device of the caller's IP address, or notifies each device of the other's IP address). The caller then communicates directly with the called device via the Internet.

In the discussions of the PSTN, it will be understood that the PSTN is no more a monolithic whole than is the Internet. It is comprised of very many telephone companies and authorities, each having very many switching centers (telephone company Central Offices). In an arrangement wherein “the PSTN” maintains a cross-reference between phone numbers and IP addresses, an authority, company, regional district, or Central Office would maintain such a cross-reference for local subscribers, and depend on other authorities, companies, regional districts, or Central Offices to maintain the same information for their own local subscribers.

There are five primary scenarios involved in the establishment of an integrated Internet/PSTN call. In the first scenario, the telephone central office switching system receives a digital call setup message, which includes the calling device's IP address (the other scenarios presume that the call setup message does not include the calling device's IP address). The call setup message could be received by the switching system directly from the calling device, from a switching system interface device (VoIP, DSL, cable-TV, etc.) that provides Internet and telephony services to its client devices, or, via the SS7 messaging system, from another telephone central office switching system where the call originates. In its most simple implementation, the switching system forwards the digital call setup message, or the essential elements of such a message, to the called device using an available messaging communications medium, such as ISDN, SS7, or one yet to be defined. That message is sent directly to the called device if it is directly connected to the switching system, via a switching system interface device (again, VoIP, DSL, etc.) if the device is a client of such an interface system, or, if the called device is served from another switching system, sent via SS7 to the terminating central office switching system which provides telephone service for the called device. For messages to be sent via a switching system interface device (VoIP, DSL, etc.), the interface device must subscribe to the arrangement described in the co-pending patent application “Telephone Central Office Switch Interface With Messaging Channel For Integrating The PSTN With The Internet”, U.S. patent application Ser. No. 60/301,758, Attorney Docket No. 0054-5.

The called device, upon receiving such a call setup message, may accept or reject the requested Internet connection (perhaps its connection to the Internet is temporarily out of service) by sending a return message to the central office switching system. If it chooses to accept the request, since now it has the IP address of the caller, the called device simply sends a call acceptance message via the Internet directly to the calling device, and an Internet communication will then commence. That acceptance message could also be sent in the reverse path via the switching system to the calling device, the particular path that the acceptance message traverses being unimportant to the central concepts. And then, via either Internet or switching system messaging, the two devices may mutually decide whether to conduct all communications over the Internet and abandon the PSTN portion, or to conduct any portion of the communications over the Internet and any portion over the PSTN. Obviously, then, either or both devices would send appropriate messages to the switching system to ensure it properly handled the PSTN portion of the call: i.e., set up a PSTN connection, or don't set up a PSTN connection.

In a more elegant variation of this process, the switching system determines whether or not the called device is an Integrated Device by referring to a records system which maintains subscriber service information including the TN, Integrated Device status, and perhaps other information such as the device's associated IP address and any other identifier for the device as used by the switching system. If the called device is not an Integrated Device the switching system responds to the call setup message by rejecting the request for an Internet connection, and continues by setting up a conventional analog connection to the called device. In practical implementations one might expect more robust protocols than those just described, specifying exactly how messages and requests are acknowledged, accepted, rejected, etc., (e.g., what happens if a message is not acknowledged, is there a time-out and retry, or the like), but those details are not relevant to the concepts being presented herein, and one skilled in the art should be able to craft a suitable protocol suite for this purpose by modeling after similar protocol suites.

Variations on the above process are also possible. In a first variation, the central office switching system obtains the IP address of the called device and delivers that address to the calling device, permitting the calling device to initiate the Internet communications. Optionally, the PSTN obtains the IP address of the calling device and provides that address to the called device, or the PSTN obtains the addresses of both the calling and called devices, and provides each device with the IP address of the other.

In the remaining arrangements described, it is presumed that the call setup request does not provide the IP address of the calling device. There are four of these arrangements: in one arrangement, the central office switching system retrieves the IP address from subscriber records that it maintains; in another arrangement, the central office switching system retrieves the IP address from either or both of the calling or called devices themselves; in another arrangement, the central office switching system retrieves the IP address from the interface device which provides Internet and telephony services for the calling or called device; in the last arrangement, the central office switching system retrieves the IP address from an Internet source. In all the arrangements, the fundamental process is the same: the telephone central office switching system obtains the IP address for at least one of the calling and called devices, and delivers that IP address to the other of the calling and called devices via a digital messaging system. These arrangements will be described hereinafter in greater detail.

In any of the above arrangements, the resulting “communication” between the devices could be entirely over the Internet (voice, screens, images, etc.), or part of the communication could transpire over the Internet (the screens and images, for example), and part could transpire over the PSTN (the voice communication, for example). An arrangement in which the voice communication is carried over the PSTN solves a long-standing VoIP problem—that of poor audio quality. Internet telephony arrangements have no direct way to control the path that voice message packets (or any packets) take as they traverse the Internet. The number of router hops is unpredictable, even from one packet to the next, and packets can be routed over heavily trafficked and congested links, causing lengthy delays. In addition, the congestion control mechanism utilized by Internet routers is to simply discard packets since the higher-level protocols (such as TCP and UDP) are designed to resend missing packets.

The net result, due to routing ambiguities, congestion, out of sequence packets and dropped packets, is that the delivery of Internet data has a high degree of variability from a timing perspective. In general this is not of significance in the delivery of visual information, web pages for example; we can wait for a web page to be constructed on the screen, and it doesn't matter if various parts are randomly constructed before other parts. Audio data, however, is significantly affected, and one of the biggest detractions to Internet telephony is poor quality audio. Since the receiving device must deliver the audio stream to the listener with rather precise timing, missing, out of order, or delayed audio data packets cannot be included in that audio stream. Consequently, the delivered audio stream can have voids of uncontrollable lengths, along with a variety of other undesirable audible artifacts that collectively constitute bad sound quality.

On the other hand, the PSTN provides a dedicated (channelized) connection for each telephone call, which avoids all the problems characteristic of the Internet. Consequently, then, an arrangement as provided for in this application in which visual information traverses the Internet and audio information traverses the PSTN provides the best features of each network to the resulting communications.

Advantageously, the present invention provides a method and means for a telephone central office switching system to facilitate the integration of the Internet and the PSTN so that a calling device can achieve an Internet communication with a called device by dialing the telephone number of the called device.

### BRIEF DESCRIPTION OF THE DRAWINGS

The invention will be more fully understood when reference is had to the following detailed description of the preferred embodiment of the invention and the accompanying drawings, in which:

FIG. 1 is a schematic drawing of the current state of the art, illustrating a telephone central office switching system in an environment with ISDN devices and DSL devices;

FIG. 2 is a schematic drawing of a preferred embodiment of this invention, illustrating enhancements to the environment of FIG. 1 that enable the capabilities of this invention;

FIG. 3 is a schematic drawing of another embodiment of this invention, with an Internet lookup capability added to the environment of FIG. 2;

FIG. 4 is a schematic drawing depicting the embodiment shown in FIG. 3 with the addition of a workstation having ADSI messaging capability; and

FIG. 5 depicts logical flow of the processes involved in a switching system setting up an integrated Internet/PSTN call.

### DETAILED DESCRIPTION OF THE INVENTION

This invention provides a telephone central office switching system having unique features and methods of operation that enable the integration of the Internet with the PSTN; more specifically, it enables a calling device to establish an Internet communication with a called device simply by dialing its telephone number. One benefit of such integration is that traditional voice-only telephone calls can be augmented or replaced with multimedia communications using Internet protocols and capabilities. Such multimedia communications may include: voice and other audio; graphics, images and other visual material; motion video; and synchronized audio and video transmitted together including TV video and videophone service. The data for these multimedia communications are transmitted on the Internet as a result of the integration described herein.

Several of my co-pending patent applications describe various aspects of this integration; the enhanced capabilities provided by the present invention facilitate that integration. The following provides an overview of the co-pending patent applications.

Co-pending patent application entitled “Integrated Device For Integrating The Internet With The Public Switched Telephone Network”, U.S. patent application Ser. No. 60/301,756, Docket No. 0054-3, describes “Integrated Devices”, for integrating the Internet with the PSTN, which have an Internet connection with an associated IP address, a PSTN connection with an associated telephone number, and a digital messaging connection to the PSTN for conveying call management messages to include messages containing telephone numbers and IP addresses.

Co-pending application entitled “Integrating the Internet with the Public Switched Telephone Network”, Docket No. 0054-4, describes an enhanced communications environment in which a telephone call placed to an Integrated Device creates end-to-end communications over the Internet rather than over the PSTN. The present invention augments the system disclosed by co-pending application Docket No. 0054-4 by providing a method and means for enabling a telephone central office switching system to engage in specific messaging communications to individual telephony and Internet devices. Such messaging facilitates end-to-end Internet communications.

There exists a class of devices, such as those for Voice over IP, DSL, cable TV, fixed wireless, Internet capable wireless cellular, and similar distribution systems, which provide Internet and telephony services to client devices, such as phones and PCs, by providing an interface to the telephone company central office switching system. Co-pending application entitled “Telephone Central Office Switch Interface With Messaging Channel For Integrating The PSTN With The Internet”, U.S. patent application Ser. No. 60/301,758, Attorney Docket No. 0054-5, discloses a method and means for providing specific messaging capabilities between a telephone central office switching system and this class of interface device, enabling the integration of the Internet with the PSTN. The communications link carries call setup, telephone number, and IP address messages to and from the switching system and to and from the client devices of the interface device.

Co-pending patent application entitled “Integrated Telephone Central Office Systems For Integrating The Internet With The Public Switched Telephone Network”, U.S. patent application Ser. No. 60/306,293, Attorney Docket No. 0054-8, discloses an integrated assembly of telephone central office switching system integrated interface devices, comprising telephone central office switching systems, and switching system interface devices such as those for providing DSL service, Voice over IP (VOIP) service, cable modem service, fixed wireless service, and Internet capable cellular wireless service. The integrated telephone central office systems therein described offers efficiencies and economies further benefiting the integration of the Internet with the PSTN.

A messaging system such as that specified in the co-pending patent application entitled “Call Management Messaging System For Integrating The Internet With The Public Switched Telephone Network”, U.S. patent application Ser. No. 60/311,401, Attorney Docket No. 0054-9, exchanges call management messages such as call setup requests, call disconnect messages, Call Forwarding messages, and so on, between communications systems and user devices, either being connected to the Internet, the PSTN, or to both.

Co-pending patent application entitled “Interactive Device Control System For Integrating The Internet With The Public Switched Telephone Network”, U.S. patent application Ser. No. 60/317,055, Attorney Docket No. 0054-11, discloses a system for the PSTN and the Internet in which a communications system offers the user of a device such as a screen phone the ability to control or influence functions of the communications system by presenting the user with a displayed menu of options. The menu of options is sent to the user's device by the communications system via a messaging system. Selection of an option by the user returns a response message to the communications system via the messaging system. Upon receipt of the response message, the communications system actuates the function associated with the user-selected option. The interactive device control system operates seamlessly across both the Internet and the PSTN, thus providing further integration of those two networks.

Co-pending patent application entitled “Stored Profile System For Storing And Exchanging User And System Communications Profiles To Integrate The Internet With The Public Switched Telephone Network”, U.S. patent application Ser. No. 60/317,057, Attorney Docket No. 0054-12, discloses a system for the PSTN and the Internet to maintain and exchange communications related information such as hardware capabilities and personal information and preferences. The Stored Profile System enables devices to synchronize and optimize their communications capabilities, and enables users to exchange contact information such as Electronic Business Cards as a part of call setup, operating like an enhanced Caller-ID. The stored profiles capability extends to communications systems on both the PSTN and the Internet, thus further promoting the integration of the Internet with the PSTN.

Central to the principles and practice of this invention, as well as the inventions described by the co-pending patent applications, is the presence of means for enabling a calling device to create an Internet communication with another device simply by dialing its telephone number, thus integrating the Internet with the PSTN. The co-pending applications describe an environment in which the various elements of the PSTN are enabled to conduct digital, packetized messages, which communicate essential information between various devices across the Internet and the PSTN to provide for this integration. Although not limited to the scope of the following listing, these enabled PSTN elements include: (i) the end or terminal devices such as telephones and Integrated Devices; (ii) telephone central switching system interface devices, such as those for VoIP, DSL, cable-TV, fixed wireless and Internet enabled cellular wireless, and the like, which provide telephony and Internet services for client devices; (iii) telephone central office switching systems which provide telephony services for client devices; (iv) telephone long distance switching systems which provide long distance capabilities on the PSTN; (v) office telephone systems such as PBXs, Key Systems and the like; and, (vi) adjunct devices such as automated attendant systems, automatic call distributors, voice mail systems, and the like.

Some of these devices, including the end or terminal devices, are uniquely addressable within the messaging system via an IP address, telephone number, or other identifier associated with the device. Other identifiers could include an internal system reference (e.g., module, cabinet, shelf, slot, port number), an ISDN (Integrated Services Digital Network) address, or the like. Regardless of the nature of the address, Integrated Devices have messaging addresses known to the serving system such as a telephone central office switching system, telephone central office switching system interface device, office telephone system, and the like, such that the serving system can communicate with the Integrated Devices via the messaging system.

The messaging system common to this invention and the inventions of the co-pending patent applications connects between each of these devices and systems, and the messages of which the messaging system is comprised are transmitted to and between each of these devices as are necessary for any individual communication. Some devices and systems may simply act as a pass-through for the message stream by passively or actively forwarding messages, or may act as a pass-through for specific message types while acting upon others. Each device or system may send, receive, forward, or act upon any given message as is necessary to accomplish the message functions. Messages may be sent in one or more pieces from one device to the next, and devices may assemble, reformat, re-packetize, augment a message with additional data, or otherwise manipulate a message as it is processed through the system.

The co-pending applications described hereinabove provide reference information useful in developing a full understanding of the present invention as it relates to these systems and devices. Accordingly, the disclosure of each aforementioned co-pending applications is incorporated herein by specific reference thereto.

Certain enhancements over the co-pending patent applications are herein described.

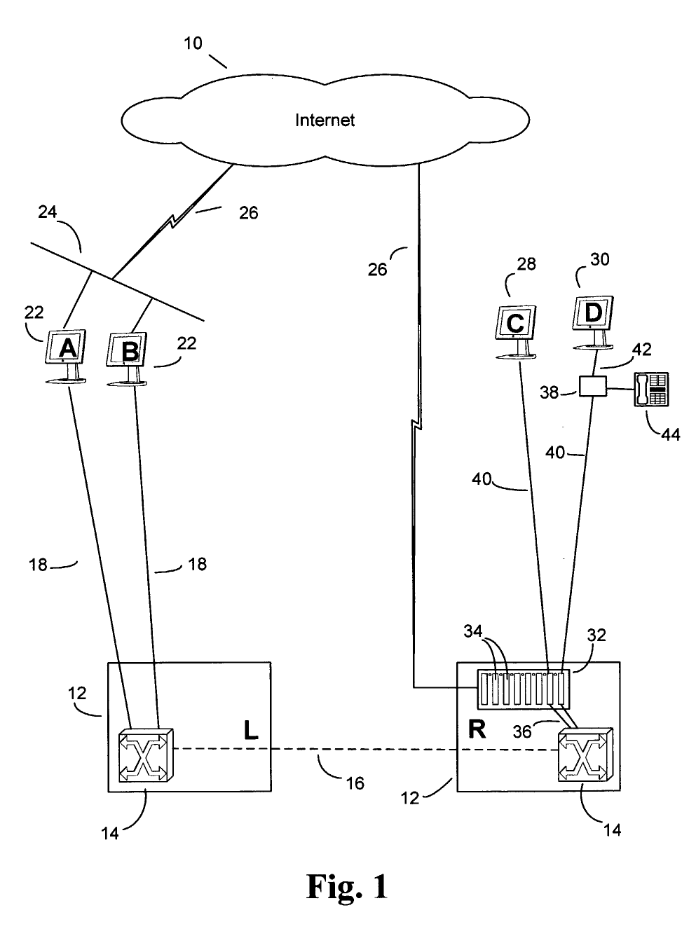

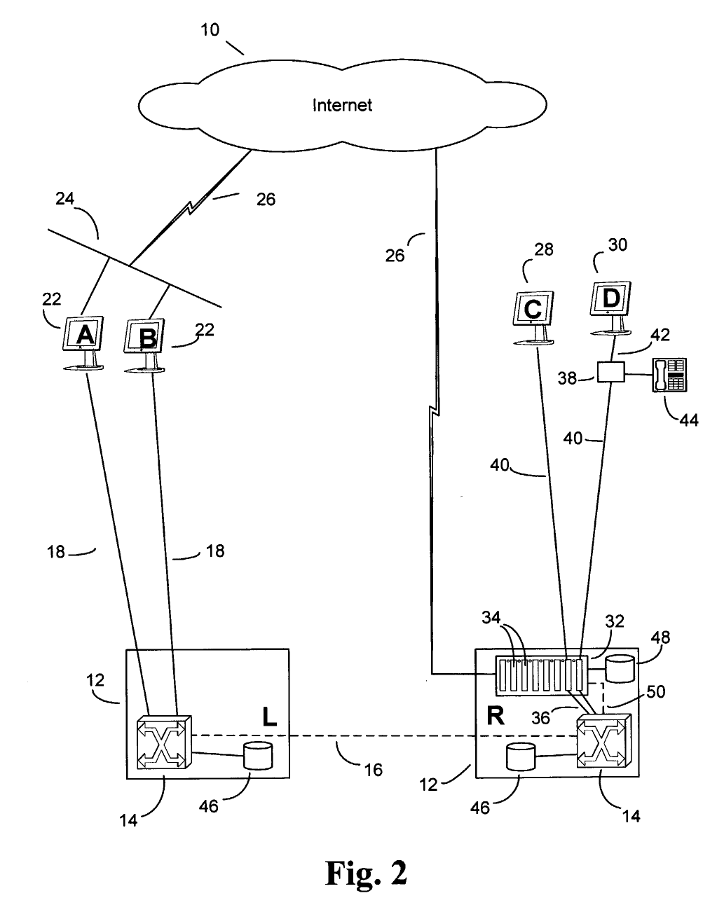

As mentioned previously, FIG. 1 depicts a conventional arrangement of two telephone central offices providing telephone services to four devices, two of which are connected to the Internet via a LAN connection, and two of which are connected to the Internet via DSL connections. FIG. 2 modifies the arrangement of FIG. 1 to describe one aspect of the present invention.

Referring to FIG. 2, there is shown the illustration of FIG. 1 having added thereto a records system 46 serving the central office switching systems 14, a similar records system 48 serving the DSL interface device 32, and a digital messaging link 50 carrying the transmission of digital messages between DSL interface 32 and switching system 14 labeled “R” on the right side of the illustration. Records systems 46 and 48 maintain service records for the subscriber devices of each respective system, including information as to the telephone number, IP address, or other identifiers of the device, and whether or not the device is an Integrated Device. Other identifiers of the device might include message-addressing identifiers for the purpose of delivering digital call setup and call management messages (call control messages) to the device in cases where the messaging address is different from the IP address or telephone number. DSL interface device 32 is being shown both as an explicit description of that environment, and as a model characteristic of any of this class of interface devices including Voice over IP, cable-TV, fixed wireless, and Internet capable cellular wireless, as more fully explained in the referenced co-pending patent application “Telephone Central Office Switch Interface With Messaging Channel For Integrating The PSTN With The Internet”, Docket No. 0054-5. Terminal devices 22, 28, and 30 are now Integrated Devices in that they possess the Integrated Device attributes previously described.

As mentioned previously, there are five scenarios in which the operation of the telephone central office switching system can be described. In a preferred embodiment, devices send a digital call setup request message upon call initiation. The call setup request message includes the IP address of the calling device, along with the dialed telephone number. Optionally, the call setup request message includes the telephone number of the calling device.

With continued reference to FIG. 2, presume that Integrated Device A (22), an ISDN device, dials the telephone number of Integrated Device C (28), a DSL device. Integrated Device A sends a call setup message via the ISDN messaging capability to its respective telephone central office switching system 14, shown on the left and labeled “L”. We can presume that the ISDN protocol may have been modified as necessary to accommodate any messages newly required by this patent application. Depending upon the implementation, the call setup message from Integrated Device A may implicitly or explicitly specify that the calling device is in fact an Integrated Device capable of an Internet communication. If this information is not available from the call setup message, switching system L, by referring to records 46 determines whether or not device A is an Integrated Device. If it is not an Integrated Device, switching system L handles the call as an analog phone call. If it is an Integrated Device, switching system L determines from the called TN that the called device is served by switching system 14 on the right and labeled “R”, and forwards or otherwise sends an equivalent call setup message to switching system R. If the original call setup message did not include an indication of whether or not the calling device is an Integrated Device, switching system L will add that information to the call setup message being sent to switching system R. Switching system R receives the call setup message, determines that it provides service for the called TN, and looks up in its service record system 46 to determine whether or not the called device is an Integrated Device. Having determined that the called device C is an Integrated Device capable of Internet communications, switching system R forwards the digital message or otherwise sends an equivalent call setup message to DSL interface device 32 via messaging communications link 50. If necessary, DSL interface device 32 looks up the called TN in its record system 48 to determine proper routing or other information relevant to delivering the call setup message to the called device. DSL interface device 32 then forwards or otherwise sends an equivalent call setup message to Integrated Device C via carrier wave link 40, which is inherently capable of conveying digital messages. In this arrangement or any similar arrangement, the interface device could be a passive element in the messaging path, allowing the switching system to communicate directly with the terminal devices, and vice versa.

Integrated Device C, now having a call setup request message that includes the IP address of the caller, may elect whether or not to accept the call setup request, and whether or not to accept the Internet communication request. The called device could, for example, simply send an acceptance message across the Internet to the calling device's IP address, resulting in the desired Internet communication. In addition, or as an alternative, it could send an acceptance message back through the chain of systems and devices that conveyed the call setup request. Preferably, that acceptance message would include the called device's IP address, allowing the calling device, after receiving the called device's IP address, to begin a direct communication with that device over the Internet. Alternatively, the called device could send a rejection of the Internet request, and acceptance of an analog phone call, via a return message retracing the path of the switching systems and devices that the call setup message had passed through. Switching system R would then complete the call as an analog telephone call.

If switching system R had determined that the called device was not an Integrated Device, it would ignore the Internet aspect of the call setup message, and complete the connection as an analog telephone call. In this fashion, a calling device need not know whether or not the called device is capable of Internet communications: if it is not capable, an analog phone call will be completed, just as happens universally today; but if it is capable of Internet communications, an Internet communication will be established automatically. All the caller needs to do is dial the phone number.

The remaining scenarios make the presumption that the calling device does not have available to it the IP address to be used for the Internet communication. For example, perhaps the call is initiated by the analog telephone 44 associated with Integrated Device D (30), simply by tone dialing. Telephone central office switching system R would receive the dialed digits, but would not receive a digital call setup message, and hence, would not have received an IP address for the caller. These scenarios hypothesize four arrangements in which an IP address could be made available to a central office switching system.

In one scenario, the records system 46 maintained by the telephone central office-switching system 14 includes the IP address for all of the devices served by that switching system. In the example of the analog phone associated with Integrated Device D tone dialing a call, telephone central office switching system R, in receiving the dialed digits, refers to the records system 46, determines the calling device's IP address, and creates a digital message to forward on to the called device, as described previously.

In another scenario, similar to the one above, the records system 48 associated with the DSL interface device 32 maintains service records for all its client devices. Following the previous example, if the analog phone associated with Integrated Device D tone dialed a call, telephone central office switching system R, in receiving the dialed digits, sends a request message to DSL interface device 32 for the desired information via messaging communications link 50. DSL interface device 32 then obtains the IP address of the calling device by referring to its records system 48, and supplies that information to the switching system R by a reply message, again via messaging communications link 50. Switching system R, now having the calling device's IP address along with the called TN, and, of course, having the calling TN, known internally by the physical connection of the line carrying the dialed digits, creates a call setup message to send on to the destination device via the paths previously described.

In yet another scenario, the Integrated Device itself stores the record of its TN and IP address. Again following the previous example, if the analog phone 44 associated with Integrated Device D tone dialed a call, telephone central office switching system R, in receiving the dialed digits, sends a request message to the Integrated Device 30, associated with the calling phone 44. The message travels via messaging communications link 50 to DSL interface device 32 and on to the Integrated Device D (30) via the carrier wave link 40. Integrated Device D then sends a response message to switching system R via the same path, thus supplying the switching system R with the IP address of the calling device.

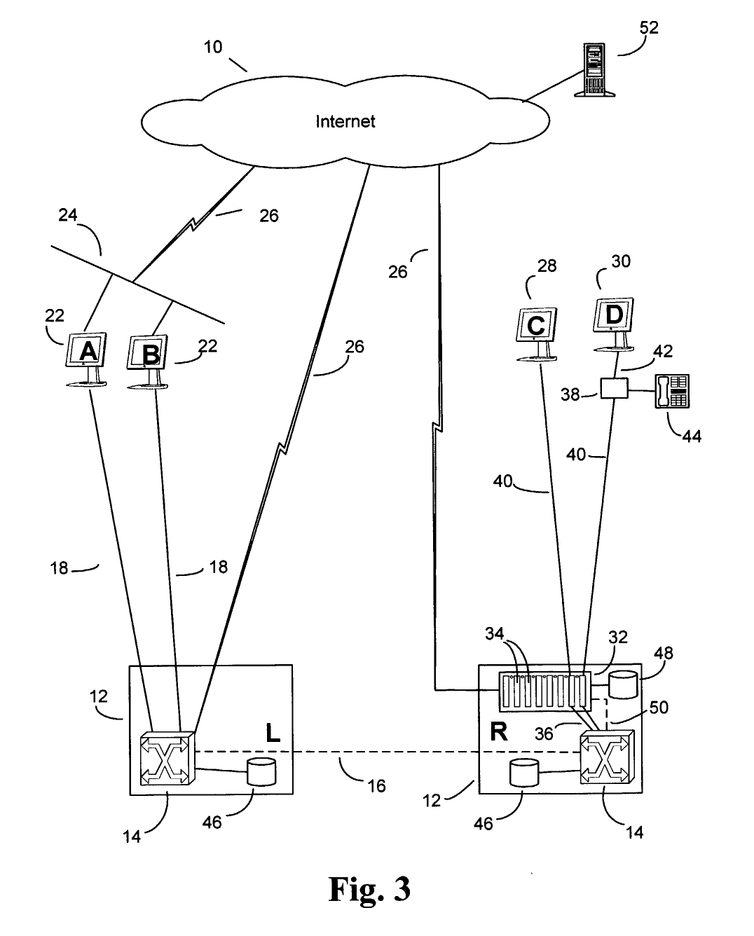

In the last scenario, presume that it is less advantageous for systems like individual telephone central office switching systems and DSL interface devices to maintain records of IP addresses associated with telephone numbers, and instead, that information is maintained in the Internet, perhaps as an extension of the DNS (Domain Name Service) server facility. This scenario is best explained with reference to FIG. 3, which shows the system of FIG. 2, but now with an Internet server 52 maintaining the records as just discussed, and with telephone central office switching systems, such as switching system L (14) having an access link 26 to the Internet. In this arrangement, the switching system sends an Internet request message to server 52 containing the telephone number, and receives a reply message containing the IP address. The remaining processes would then be much the same as previously described for these scenarios.

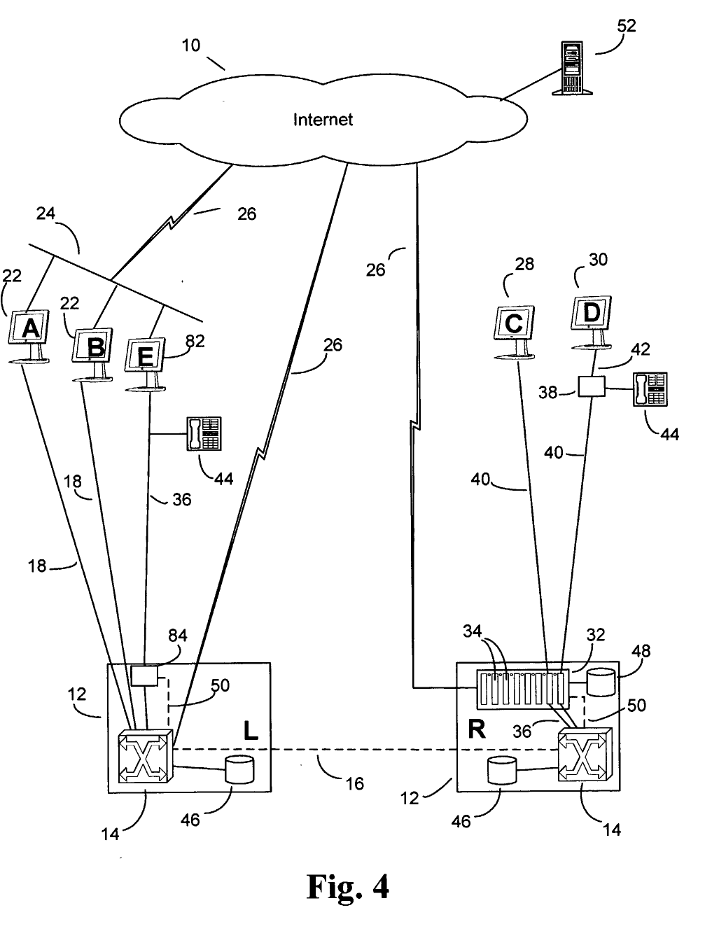

FIG. 4 extends the diagram of FIG. 3 with the addition of a workstation 82 labeled E and having an internal ADSI modem capability (not shown). Workstation E has associated with it an analog telephone 44, and both are connected to the telephone central office switching system 14 by an analog phone line 36. Within the telephone central office, phone line 36 is associated with an ADSI modem 84 having a messaging communications link 50 to the switching system 14 for carrying call management and IP messages.

As one example of the operation in this environment, assume that workstation C calls the telephone number of ADSI workstation E, and that either DSL interface device 32 obtains the IP address for workstation C from its cross-reference 48, or switching system 14 obtains the IP address for workstation C from its cross-reference 46. In either case, the IP address for workstation C is added to a call setup request message which is sent to telephone central office L. Switching system 14 in central office L delivers an appropriate call setup request message incorporating the calling device's IP address to ADSI modem 84 via messaging link 50. ADSI modem 84 then sends an equivalent message, also containing the IP address, to workstation E. Workstation E then possessing the IP address of workstation C can initiate an Internet communication with workstation C.

In an ADSI environment the ADSI messaging system communicates the IP address and associated call control data from the telephone central office to the terminal (user) device; other messaging arrangements, such as SS7, ISDN, or the Internet, are used to communicate that information between central offices and associated systems such as a DSL interface device.

Each of the scenarios just described defines the mechanism by which the central office switching system obtains the IP address of the calling device and delivers it to the called device. Having defined the messages, messaging communication links, and records systems, it would be trivial to modify the process to instead obtain the IP address of the called device and deliver it to the calling device, or even to obtain both IP addresses and deliver each IP address to the other device. Inasmuch as any of these three arrangements will work, and each of them is encompassed by the scope of this invention, they have been included by mentioning their applicability as alternatives rather than describing their operations in detail. Furthermore, even though attention has been paid to the use of the SS7, ISDN, and ADSI facilities for delivering the IP address enabled call management messages, the Internet could also be used for such communications. Consider FIG. 3 in which switching system “L” 14 has an Internet connection 26. That Internet connection could be used to send messaging communications to DSL interface device 32, and indirectly via DSL interface device 32 to Integrated Devices 28 or 30. Although not shown, if switching system “R” 14 had similar Internet connectivity 26 to that of switching system “L” 14, it could send call management messages directly to workstations 22 A and B.

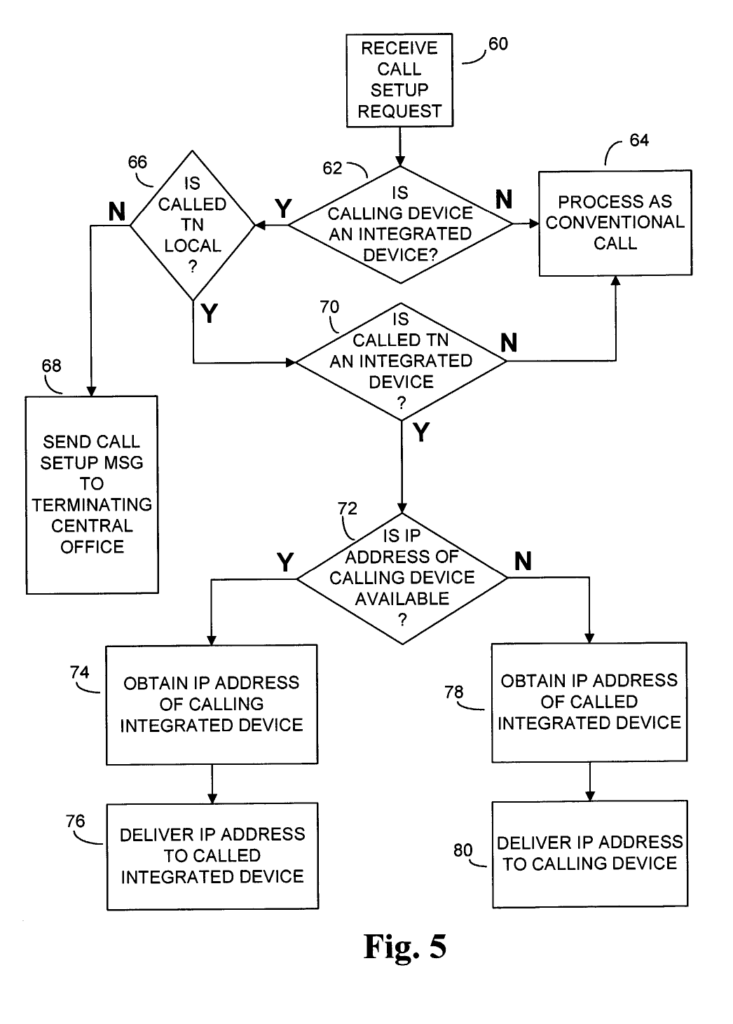

Next described is a generic method of operation of a telephone central office switching system for a preferred embodiment of the invention. The key operation is for the telephone central office switching system to obtain the IP address of one of the calling and called devices, and deliver that IP address to the other of the calling and called devices. FIG. 5 provides a logical flow chart of the processes involved for a switching system to handle a call setup request in an integrated Internet/PSTN environment. Referring to FIG. 5, the switching system at 60 receives a call setup request directly from a device or indirectly via a calling device, an interface device, or a remote central office switching system. The switching system 62 via the call setup request message or via records information determines if the calling phone is an Integrated Device. If it is not, the call is processed as an analog phone call at 64. If it is an Integrated Device, the switching system, via internal records, determines at 66 if the called telephone number is served locally by the switching system. If it is not served by the local switching system, the call setup request is forwarded at 68 in the form of a digital message via the SS7 network to the terminating central office switching system for processing. If the called device is locally served, then at 70 the switching system, via internal records, determines if the called TN is an Integrated Device. If not, the switching system processes the call at 64 as an analog phone call. However, if the called device is an Integrated Device, then at 72 the switching system determines if the IP address of the calling device is available via one of the scenarios previously discussed. Perhaps, for example, the IP address is included in the call setup message from the calling device. If it is available, the switching system at 74 obtains the IP address of the calling device, and at 76 sends the IP address in a call setup message to the called device, whereupon the calling and called devices can commence communication over the Internet. If, however, the IP address of the calling device is not available, then at 78 the switching system obtains the IP address of the called Integrated Device, and at 80 sends the IP address in a call setup message to the calling device, whereupon the calling and called devices can commence communication over the Internet.

It will be understood that in these discussions the reference to a telephone central office switching system is intended to be a general term, and that there may actually be a number of interconnected devices and systems in the central office that work cooperatively to perform these functions; for example, some of these functions might be performed by an adjunct processor, or the like. Therefore, the term “switching system” is intended to refer to the switching system itself, or any adjunct or support system, or any system acting as a proxy or agent for the switching system.

It also will be understood by those skilled in the art that for various reasons a telephone carrier might choose to have a centralized records system accessible by multiple switching systems, rather than a separate records system for each switching system. The telephone carrier must then provide a communications facility for the switching systems to access the records system. The capability to provide such a facility is well known in the art. Similarly, the providers of interface devices for DSL, cable-TV, and the like, may have centralized records systems, and thus also must provide a communications facility for the interface devices to access the records system; the capability to provide such facility also is known in the art.

Having thus described the invention in rather full detail, it will be understood that such detail need not be strictly adhered to, but that further changes and modifications may suggest themselves to one skilled in the art falling within the scope of the present invention as defined by the subjoined claims.

What is claimed is:

1. A telephone central office switching system of the Public Switched Telephone Network (PSTN) having means for enabling a calling device to establish an Internet communication with a called device by dialing its telephone number.

2. A telephone central office switching system as recited in claim 1, wherein said means for enabling a calling device to establish an Internet communication with a called device by dialing its telephone number is a messaging communications means which carries call setup and call control messages to include Internet Protocol (IP) address information of a calling or called device.

3. A telephone central office switching system as recited in claim 2, wherein said messaging communications means comprises other elements of the PSTN.

4. A telephone central office switching system as recited in claim 2, wherein said messaging communications means comprises interface devices for providing Internet and telephony services to client devices capable of placing or receiving calls, and for providing an interface between said client devices and the PSTN.

5. A telephone central office switching system as recited in claim 2, wherein said messaging communications means comprises Integrated Devices, each having an Internet connection and a telephone number, the Internet connection having an associated Internet Protocol (IP) address, and the telephone number having an associated telephone connectivity, such that a connection for said Integrated Devices is established by telephonically dialing said telephone number via the PSTN.

6. A telephone central office switching system as recited in claim 1, wherein said means for enabling a calling device to establish an Internet communication with a called device by dialing its telephone number further comprises means for completing a conventional telephone call over the PSTN between said calling and called devices if an Internet communication between said calling and called devices cannot be achieved.

7. A telephone central office switching system as recited in claim 1, wherein said means for enabling a calling device to establish an Internet communication with a called device by dialing its telephone number further comprises means for carrying the audio aspects of a communication over the PSTN and visual or graphical aspects over the Internet.

8. A telephone central office switching system as recited in claim 2, wherein said messaging communications means utilizes the PSTN SS7 network.

9. A telephone central office switching system as recited in claim 2, wherein said messaging communications means utilizes the PSTN ISDN network.

10. A telephone central office switching system as recited in claim 2, wherein said messaging communications means utilizes the Internet.

11. A telephone central office switching system as recited in claim 2, wherein said messaging communications means is compatible with Analog Display Screen Interface (ADSI) technology.

12. A telephone central office switching system having means for enabling a calling device to establish an Internet communication with a called device by dialing its telephone number, comprising:
(a) means for providing telephone services to telephones, telephone systems, and similar telephone devices, including Integrated Devices, each having an Internet connection and a telephone number, the Internet connection having an associated Internet Protocol (IP) address, and the telephone number having an associated telephone connectivity, said Integrated Devices being capable of creating an Internet communication by dialing the telephone number of another Integrated Device;
(b) means for connecting to other telephone central office switching systems for telephone communications;
(c) messaging communications means to said other telephone central office switching systems to communicate digital call management and call control messages related to the establishment and disestablishment of said telephone communications, said messaging communications means to communicate digital messages carrying IP address information;
(d) switching means for establishing telephone communications to said telephone devices for which said switching system provides telephone services;
(e) connection means for establishing telephone communications to said telephone devices for which said switching system provides telephone services; and
(f) said messaging communications means being associated with said Integrated Devices to communicate digital call management and call control messages carrying IP address information.

13. A telephone central office switching system as recited in claim 12, further comprising:
(a) connection means associated with interface devices that provide Internet and telephony services to client devices; and
(b) said messaging communications means being further associated with said interface devices to communicate digital call management and call control messages carrying IP address information for said client devices of said interface devices.

14. A telephone central office switching system as recited by claim 12, further comprising a records system associated with said telephone central office switching system, said records system maintaining a cross-reference relating telephone number and IP address information associated with said Integrated Devices served by said central office switching system.

15. A records system of a telephone central office switching system as recited by claim 12, further comprising message addressing identifiers for message communications with said Integrated Devices.

16. A telephone central office switching system as recited by claim 12, further comprising means for said telephone central office switching system to obtain said IP address information associated with said Integrated Devices served by said central office switching system from a cross-reference relating IP address information and telephone number information.

17. A telephone central office switching system as recited by claim 16, wherein said cross-reference is maintained in the Integrated Devices.

18. A telephone central office switching system as recited by claim 16, wherein said cross-reference is maintained in the PSTN.

19. A telephone central office switching system as recited by claim 16, wherein said cross-reference is maintained in the Internet.

20. A method for operating a telephone central office switching system, comprising the steps of:
(a) receiving a call setup request for a calling device;
(b) determining whether said calling device is an Integrated Device;
(c) processing the call setup request as a conventional telephone call when said calling device is not an Integrated Device;
(d) determining whether the IP address of said calling device is available, such determination being made under circumstances wherein said calling device is an Integrated Device;
(e) obtaining said IP address of said calling Integrated Device; and
(f) delivering said IP address of said calling Integrated Device to said called Integrated Device.

21. A method for operating a telephone central office switching system as recited in claim 20, further comprising the steps of:
(a) obtaining the IP address of said called Integrated Device; and
(b) delivering said IP address of said called Integrated Device to said calling Integrated Device.

22. A method for operating a telephone central office switching system, as recited by claim 20, further comprising the steps of:
(a) determining whether the called telephone number is served by said telephone central office switching system; and
(b) sending a call setup request message to the telephone central office switching system that serves said called telephone number, said call setup request message being sent under circumstances wherein said called telephone number is not served by said telephone central office switching system.
